(19) United States
(12) Patent Application Publication
(10) Pub. No.: US 2012/0002789 A1
(43) Pub. Date: Jan. 5, 2012

(54) REPAIRABLE MONOBLOCK X-RAY GENERATING DEVICE

(76) Inventors: Gwenael LEMARCHAND, Buc (FR); Philippe Ernest, Buc (FR); Philippe Blin, Buc (FR); Thierry Toledo, Buc (FR); Daniel Dumourier, Buc (FR)

(21) Appl. No.: 13/161,888

(22) Filed: Jun. 16, 2011

(30) Foreign Application Priority Data
Jun. 16, 2010 (FR) 1054766

(51) Int. Cl. H05G 1/10; H01F 27/08

(52) U.S. Cl. 378/101; 336/55

(57) ABSTRACT

A monoblock X-ray generating device is provided. The device includes a rotor, a stator, an anode and a cathode positioned in a first module, the first module comprising a first cooling circuit. The device further includes a high voltage transformer positioned in a second module, the second module comprising a second cooling circuit. The first and second cooling circuits are positioned apart from each other, and one of the first and the second modules comprises a male connector and the other of the first and the second modules comprises a mating female connector.

### BACKGROUND OF THE INVENTION

1. Field of the Invention

Embodiments of the present invention relate to X-ray generating devices, and more particularly to X-ray tubes.

2. Description of the Prior Art

X-ray generating devices typically comprise two components: an X-ray tube and a high voltage generator.

Old designs of X-ray generating devices comprise a body in which an X-ray tube, powered by a high voltage transformer, is positioned. The high voltage transformer is also positioned in said body. The body is commonly filled with mineral oil in order to ensure cooling of the X-ray tube. The X-ray generating device also comprises lead components so as to prevent diffusion of X-ray in certain directions.

These devices in which the X-ray tube and the high voltage generator are positioned in a same body are defined by the IEC 60788 Ed.2 standard as being devices of the monoblock type. These devices are distinguished from devices in which the X-ray tube and the high voltage generator are positioned in distinct casings and connected by a cable.

Monoblock generators have advantages in regards to this type of generator. Notably, monoblock generators tend to be less costly and more reliable because of the absence of a cable between the components.

However, the life-time of these X-ray generating devices is not satisfactory. Also, the various components have differing life-times. A high voltage generator typically has a life-time of about ten years, while X-ray tubes have a life-time of less than ten years. The monoblock devices also have a complex structure that does not allow for the simple replacement of the X-ray tube or of the high voltage transformer. The complexity of such a replacement causes such a replacement to have a prohibitive cost and generally leads to replacing the whole device.

Solutions aiming at improving X-ray generating devices have been proposed, notably in terms of bulkiness, manufacturing and materials used.

Document FR 2844176 in the name of the applicants presents an X-ray generating device with an enhanced X-ray tube, comprising a cooling circuit in the form of an air circuit, and an electric insulation device as a ceramic connector.

The ceramic connector as shown in this document is sealed in a tube via a metal washer.

The connector, mechanically and electrically a female connector, receives a matching mechanical and electrical male connector with a rubber sheath.

The sheath of the male connector holds connection strands and is engaged into a brass flange. This brass flange is pushed back by a lid screwed onto the X-ray tube in the direction of the female connector. The lid screwed onto the tube comprises, for this purpose, a retractable neck which bears upon a crown. The crown pushes a spring supported on the flange, which typically has a polarizing device provided for engagement into a cavity made in the crown.

With this solution it is possible to do without the mineral oil and the lead which were used previously in X-ray generating devices. These components posed problems because of their non-biodegradable nature, notably during recycling at the end of the life of these apparatuses.

Document FR 2845241 presents an X-ray emitting device comprising a body in which are positioned an anode and a cathode, said body producing a vacuum-proof seal and comprising an aperture in which a high voltage connector is positioned, which blocks said aperture in a vacuum-proof way.

Thus, this document proposes to produce thermal insulation by the vacuum in the body of the X-ray emitting device.

The X-ray tube proposed by this document is considerably lightened, by an amount of the order of 30-50%, as compared with prior X-ray tubes.

These solutions therefore have advantages in terms of materials used and in terms of bulkiness, but do not address the problem of replacement of the components.

It is therefore sought to develop an X-ray generating device preserving these advantages in terms of cost, bulkiness and materials used, while allowing replacement of the individual components when the latter have failed.

### SUMMARY OF THE INVENTION

In accordance with one embodiment of the present invention, a monoblock X-ray generating device is provided. The device comprises a rotor, a stator, an anode and a cathode positioned in a first module, the first module comprising a first cooling circuit. The device further comprises a high voltage transformer positioned in a second module, the second module comprising a second cooling circuit. The first and second cooling circuits are positioned apart from each other, and one of the first and the second modules comprises a male connector and the other of the first and the second modules comprises a mating female connector.

In accordance with an alternate embodiment of the present invention, a module is provided. The module comprises a high voltage transformer and a cooling circuit, the module further comprising a high voltage connector directly connected to the high voltage transformer.

### BRIEF DESCRIPTION OF THE DRAWINGS

Other features, objects and advantages of the embodiments of the present invention will become apparent from the following description, which is purely an illustration and not a limitation, and which should be read with reference to the appended drawings, wherein:

FIG. 1 shows two modules of a repairable monoblock X-ray generating device in accordance with an embodiment of the present invention;

FIG. 2 shows an assembled view of the module shown in FIG. 1 in accordance with an embodiment of the present invention.

### DETAILED DESCRIPTION OF THE INVENTION

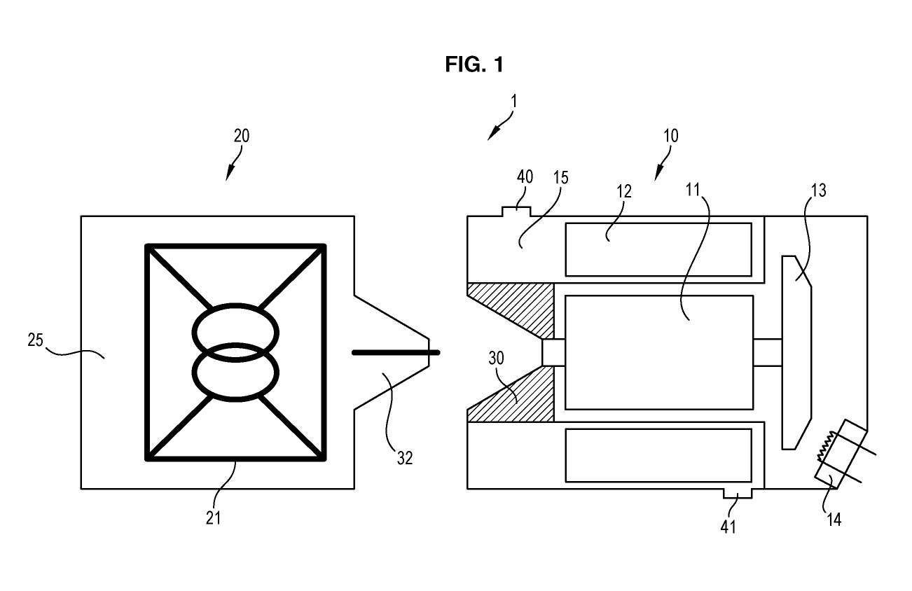

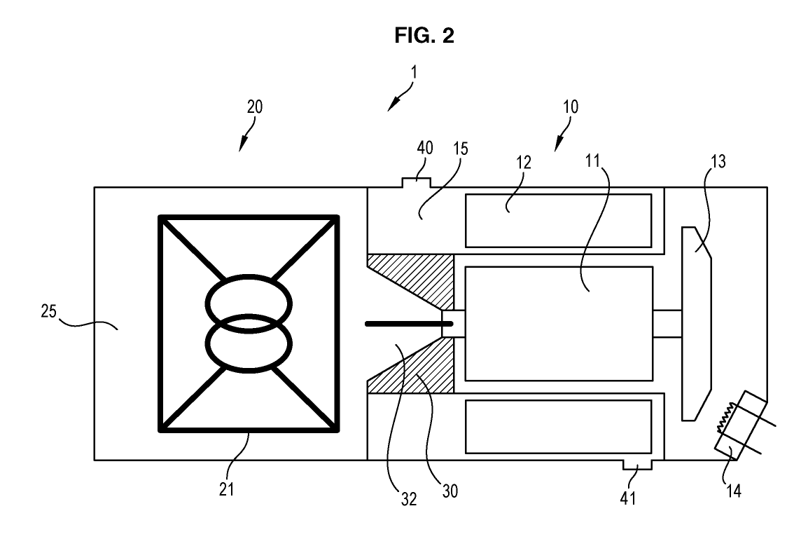

FIGS. 1 and 2 show a monoblock X-ray generator 1, the body of which consists of two modules: a first module 10 and a second module 20.

The first module comprises a rotor 11, a stator 12, an anode 13 and a cathode 14, that corresponds to an X-ray tube. The first module moreover comprises a first cooling circuit 15 having an air intake 16 and an air outlet 41.

The second module 20 comprises a high voltage transformer 21 and a second cooling circuit 25.

As shown in FIGS. 1 and 2, the first module 10 comprises a stator 12 positioned on the periphery of said first module 10, thereby defining an internal space, and a rotor 11 positioned in said internal space defined by the stator 12.

In the illustrated embodiment, the rotor 11 is connected to the high voltage transformer 21, and with the anode 13 which rotates relatively to the stator 12 and appears as a disk firmly attached to the rotor 11, positioned in the extension of said rotor 11.

The anode 13 typically comprises a peripheral field 16 coated with a metal layer capable of emitting X-rays.

The cathode 14 may be fixedly connected to the ground and positioned facing the peripheral field 16 of the anode 13.

An electron current is produced between the cathode 14 and the anode 13, which will be slowed down by the atoms of the anode 13, and will thereby emit X-radiation. This X-ray generation causes a significant release of heat, requiring that the X-ray tube be cooled as well as the high voltage transformer.

The illustrated embodiment in which the anode 13 is rotating allows dissipation of heat on its circumference, and significant X-ray intensities may thereby be obtained.

Other embodiments are possible, notably embodiments in which the anode 13 is fixed, such solutions being notably utilized for certain applications in medical imaging.

As shown in FIGS. 1 and 2, the first cooling circuit 15 is an air cooling circuit, and comprises an air intake 40 and an air outlet 41 positioned on the periphery of the first module 10. Air flow is then optimized so as to cool the stator 12 and the high voltage connector 30.

Other embodiments are possible; the cooling circuit 15 of the first module may for example be an open or closed cooling circuit.

The cooling circuit may be designed so that the cathode 14 and the casing of the tube 10 are also cooled in addition to the stator 12.

The second cooling circuit 25 of the second module 20 typically comprises a solid insulation material for example silicone or epoxy, surrounding the high voltage transformer 21.

Other embodiments are possible, notably an air cooling circuit for the second module 20.

The outer insulation towards X-radiation generated by the X-ray tube is obtained by the thickness of the first module 10, which is typically made in steel. The walls of the first module have in all directions sufficient thickness for efficiently blocking all the emitted X-rays, except for the desired emission direction.

By acting in this way on the thickness of the first module 10, the use of lead is avoided, which although efficient for blocking X-radiation, poses environmental problems.

The X-ray generating device 1 as illustrated therefore has advantages in terms of manufacturing and materials used as compared with prior devices using mineral oil and lead.

As illustrated in the figures, the connection between the first module 10 and the second module 20 is made by means of a high voltage connector 30. The high voltage connector may typically be made in ceramic.

Other embodiments are possible in which the high voltage connector 30 is made in an insulating material of the oxide type.

The high voltage connector 30 is sealed in the first module 10 and has a mechanically female frusto-conical shape.

The second module 20 may comprise a mating male connector 32, adapted so as to be housed in the mechanically female frusto-conical shape of the high voltage connector 30, so as to achieve a mechanical connection between both modules 10 and 20. The high voltage generator 21 is directly connected to the male connector 32 of the high voltage connector 30.

Other shapes may be used for the connectors 30 and 32, for example two planar surfaces facing each other, one in ceramic and the other in rubber.

A monoblock X-ray generator 1 is therefore made by connecting both modules 10 and 20 as illustrated in FIG. 2.

With the high voltage connector 30, it is further possible to achieve electric insulation of the X-ray tube and of the high voltage transformer 21.

The first and second cooling circuits 15 and 25 are apart from each other, so that the first module 10 and the second module 20 may be easily separated and assembled. This assembling or disassembling is facilitated because of the use of the high voltage connector 30, with which a connection may be made between both modules 10 and 20, while ensuring insulation thereof

Thus, in the case of failure of the high voltage transformer 21 of the second module, or of the X-ray tube of the first module 10, it is possible to replace one of the two modules 10 or 20 so as to only replace the faulty component, without necessitating the replacement of the whole of the X-ray generating device 1.

The cost of the X-ray generating device is reduced at several levels as compared with conventional devices. The use of simple parts and of cooling circuits not using any oil allows a reduction in the production costs, and the possibility of independently replacing the first module 10 or the second module 20 reduces the costs of maintenance and use.

The produced X-ray generating device therefore retains the advantages of monoblock X-ray generating devices, while exhibiting a modular aspect allowing replacement of a faulty component of the device.

Exemplary applications of this X-ray generating device are found in radiography, mammography, radiofluoroscopy devices, and may more generally be used in any X-ray imaging system.

Although FIGS. 1 and 2 show a monopolar tube (transformer and anode at a high voltage and grounded cathode), embodiments of the present invention also apply to bipolar tube (anode and cathode at opposite high voltage).

In this case, two modules of the type of the second module 20 are required, a first one connecting a transformer to the anode, the second connecting a transformer to the cathode.

What is claimed is:

1. A monoblock X-ray generating device comprising:
a rotor, a stator, an anode and a cathode positioned in a first module, the first module comprising a first cooling circuit;
a high voltage transformer positioned in a second module, the second module comprising a second cooling circuit,
wherein the first and second cooling circuits are positioned apart from each other, and
wherein one of the first and the second modules comprises a male connector and the other of the first and the second modules comprises a mating female connector.

2. The device according to claim 1, wherein the male connector is of a ceramic or an oxide type.

3. The device according to claim 1, wherein the second cooling circuit comprises a solid insulation material.

4. The device according claim 3, wherein the solid insulation material comprises silicone or epoxy positioned in the second module.

5. The device according to claim 1, wherein the second module comprises a liquid insulation circuit.

6. The device according to claim 1, wherein the first cooling circuit is an air cooling circuit.

7. A module comprising a high voltage transformer and a cooling circuit, the module further comprising a high voltage connector directly connected to the high voltage transformer.
